(19) United States
(12) Patent Application Publication
(10) Pub. No.: US 2018/0089897 A1
(43) Pub. Date: Mar. 29, 2018

(54) MIXED COLOR CONTENT PROVIDING SYSTEM, MIXED COLOR CONTENT PROVIDING METHOD, AND COMPUTER-READABLE RECORDING MEDIUM

(71) Applicant: VIEWIDEA CO., LTD., Seoul (KR)

(72) Inventor: Ha Dong KIM, Paju-si (KR)

(21) Appl. No.: 15/334,050

(22) Filed: Oct. 25, 2016

(30) Foreign Application Priority Data
Sep. 29, 2016 (KR) 10-2016-0125592

(51) Int. Cl. G06T 19/00; G06T 3/00

(52) U.S. Cl. CPC G06T 19/006; G06T 2207/10024; G06T 3/0093

(57) ABSTRACT

A mixed color content providing system, a mixed color content providing method, and a non-transitory computer-readable recording medium are provided. The mixed color content providing system includes an imaging unit configured to acquire a two-dimensional (2D) image corresponding to a plurality of numbers and an operation symbol that constitute a mathematical operation, a calculation unit configured to calculate a result of the mathematical operation, a color mixing unit configured to extract colors respectively corresponding to the plurality of numbers and to generate mixed color information of the extracted colors, an image conversion unit configured to extract a rectangular region that surrounds the 2D image acquired by the imaging unit, and to perform image warping with respect to the extracted rectangular region to thereby generate a three-dimensional (3D) image corresponding to the 2D image, and a display unit configured to output the 3D image generated by the image conversion unit and a 3D image of a number corresponding to the calculation result from the calculation unit, wherein the 3D image of the number corresponding to the calculation result is displayed in a mixed color generated by the color mixing unit.

### CROSS-REFERENCE TO RELATED APPLICATION

This application claims the benefit of priority of Korean Patent Application No. 10-2016-0125592, filed on Sep. 29, 2016, in the Korean Intellectual Property Office, the disclosure of which is incorporated herein in its entirety by reference.

### BACKGROUND

### 1. Field

One or more embodiments relate to systems and methods for providing mixed color content and non-transitory computer-readable recording media, and more particularly, to a mixed color content providing system, a mixed color content providing method, and a non-transitory computer-readable recording medium, by which, when a 3D image is generated from a user-participating two-dimensional (2D) image, color information of the 2D image is extracted and reflected in the 3D image, and mixed color information and mathematical operation information are output together.

### 2. Description of the Related Art

Interest in virtual reality and augmented reality are increasing with developments in information technology (IT), and provision of experiences similar to reality has been attempted.

Virtual reality and augmented reality are being evaluated as technologies capable of increasing users' interest and participation, because they enable users to experience reality via virtual content. These technologies continue to be applied to various fields.

Because augmented reality technology can be implemented even when only a user terminal is present, the augmented reality technology is more likely to be able to be applied to various fields, and can be used with respect to educational content, game content, and the like.

### SUMMARY

One or more embodiments include a mixed color content providing system, a mixed color content providing method, and a computer-readable recording medium, by which users' interests are caused and users' participation is increased by generating a three-dimensional (3D) image from a two-dimensional (2D) image of a mathematical operation selected by a user and by providing a result of the mathematical operation and color mixing information.

Additional aspects will be set forth in part in the description which follows and, in part, will be apparent from the description, or may be learned by practice of the presented embodiments.

According to one or more embodiments, a mixed color content providing system includes an imaging unit configured to acquire a two-dimensional (2D) image corresponding to a plurality of numbers and an operation symbol that constitute a mathematical operation; a calculation unit configured to calculate a result of the mathematical operation; a color mixing unit configured to extract colors respectively corresponding to the plurality of numbers and to generate mixed color information of the extracted colors; an image conversion unit configured to extract a rectangular region that surrounds the 2D image acquired by the imaging unit, and to perform image warping with respect to the extracted rectangular region to thereby generate a three-dimensional (3D) image corresponding to the 2D image; and a display unit configured to output the 3D image generated by the image conversion unit and a 3D image of a number corresponding to the calculation result from the calculation unit, wherein the 3D image of the number corresponding to the calculation result is displayed in a mixed color generated by the color mixing unit.

The image conversion unit may detect a plurality of coordinates corresponding to feature points of a 2D image that has undergone the image warping, may generate the 3D image by using the detected coordinates, and may color the 3D image with colors extracted by the color mixing unit.

The image conversion unit may acquire the 3D image from a database (DB) that stores a 2D image that has undergone the image warping and a 3D image corresponding to the image-warped 2D image.

The imaging unit and the display unit may be included in a single terminal device, and the 2D image acquired by the imaging unit may be displayed together with the 3D image output via the display unit.

The color mixing unit may calculate an average value of color coordinates of the extracted colors and generate a color corresponding to the average value as the mixed color information.

The display unit may display the 3D image generated by the image conversion unit at a location corresponding to the 2D image by overlapping the 3D image with the 2D image.

According to one or more embodiments, a mixed color content providing method is performed by a terminal device including an imaging unit and a display unit and includes acquiring a 2D image corresponding to a plurality of numbers and an operation symbol that constitute a mathematical operation, by using the imaging unit; calculating a result of the mathematical operation; extracting colors respectively corresponding to the plurality of numbers and generating mixed color information of the extracted colors; extracting a rectangular region that surrounds the acquired 2D image, and performing image warping with respect to the extracted rectangular region to thereby generate a 3D image corresponding to the 2D image; and outputting the 3D image generated in the generating of the 3D image and a 3D image of a number corresponding to the result of the mathematical operation via the display unit, wherein the 3D image of the number corresponding to the result of the mathematical operation is displayed in a mixed color generated in the generating of the mixed color information.

The generating of the 3D image may include detecting a plurality of coordinates corresponding to feature points of a 2D image that has undergone the image warping and generating the 3D image by using the detected coordinates; and coloring the 3D image with colors extracted in the generating of the mixed color information.

The generating of the 3D image may include acquiring the 3D image from a DB that stores the 2D image that has undergone the image warping and a 3D image corresponding to the image-warped 2D image.

The generating of the mixed color information may include calculating an average value of color coordinates of the extracted colors and generating a color corresponding to the average value as the mixed color information.

The outputting of the 3D image may include displaying the 3D image generated in the generating of the 3D image at a location corresponding to the 2D image by overlapping the 3D image with the 2D image.

According to one or more embodiments, a non-transitory computer-readable recording medium has recorded thereon a program for executing the above-described method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic block diagram of a mixed color content providing system according to an embodiment of the present invention;

FIG. 2 illustrates a two-dimensional (2D) image of a mathematical operation that is input to the mixed color content providing system of FIG. 1;

FIG. 3 illustrates a display via a display unit according to an embodiment of the present invention;

FIG. 4 illustrates a color mixing result and a calculation result displayed via a display unit according to an embodiment of the present invention;

FIG. 5 is a schematic block diagram of a mixed color content providing system according to another embodiment of the present invention; and

FIG. 6 is a schematic flowchart of a mixed color content providing method according to an embodiment of the present invention.

### DETAILED DESCRIPTION

The attached drawings for illustrating exemplary embodiments of the present invention are referred to in order to gain a sufficient understanding of the present invention, the merits thereof, and the objectives accomplished by the implementation of the present invention. However, this is not intended to limit the inventive concept to particular modes of practice, and it is to be appreciated that all changes, equivalents, and substitutes that do not depart from the spirit and technical scope of the inventive concept are encompassed in the inventive concept. These embodiments are provided so that this disclosure will be thorough and complete, and will fully convey the scope of the inventive concept to one of ordinary skill in the art. In the description of the present invention, certain detailed explanations of the related art are omitted when it is deemed that they may unnecessarily obscure the essence of the present invention.

The terms used in the present specification are merely used to describe particular embodiments, and are not intended to limit the scope of the inventive concept. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While the terms including an ordinal number, such as “first”, “second”, etc., may be used to describe various components, such components must not be limited by theses terms. The above terms are used only to distinguish one component from another.

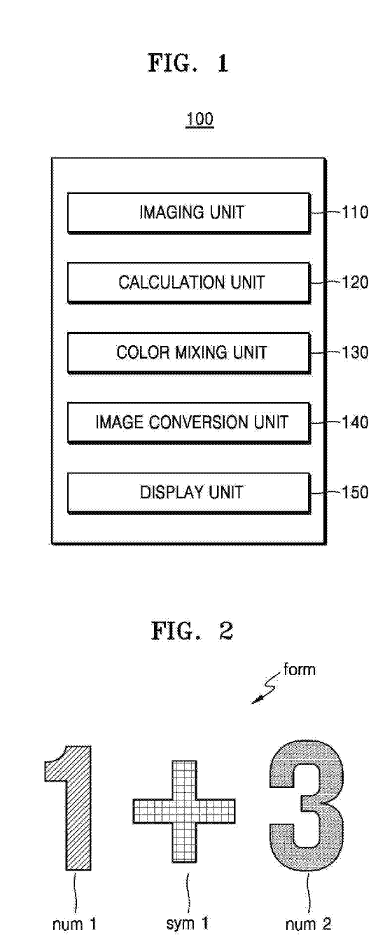

FIG. 1 is a schematic block diagram of a mixed color content providing system 100 according to an embodiment of the present invention.

Referring to FIG. 1, the mixed color content providing system 100 includes an imaging unit 110, a calculation unit 120, a color mixing unit 130, an image conversion unit 140, and a display unit 150.

The imaging unit 110 acquires a two-dimensional (2D) image corresponding to a plurality of numbers and an operation symbol that constitute a mathematical operation. The 2D image may be provided as a user-participating image, and each of the plurality of numbers may be colored by a user.

The calculation unit 120 calculates a result of the mathematical operation, and the color mixing unit 130 extracts colors respectively corresponding to the plurality of numbers and generates mixed color information of the extracted colors.

For example, when the mathematical operation is 6+3, the calculation unit 120 may calculate 9, which is a result of the mathematical operation. Accordingly, the calculation unit 120 may distinguish the numbers and the operation symbol included in the mathematical operation from the 2D image captured by the imaging unit 110. Alternatively, a 2D image of the numbers and a 2D image of the operation symbol may be distinguished from each other by the imaging unit 110.

The imaging unit 110 or the calculation unit 120 may distinguish the numbers and the operation symbol from each other by using feature point information of the 2D image corresponding to distinguishable numbers and distinguishable operation symbols. The imaging unit 110 or the calculation unit 120 may detect a 2D image including the feature point information from a screen image obtained by the imaging unit 110. When the 2D image including the feature point information is detected, the imaging unit 110 or the calculation unit 120 may provide information of the 2D image to the color mixing unit 130 and the image conversion unit 140.

When a color corresponding to 6 included in the mathematical operation and a color corresponding to 3 included therein are red and blue, respectively, the color mixing unit 130 may extract a red color and a blue color and generate mixed color information corresponding to a violet color which is a mixed color of the extracted red and blue colors.

The color mixing unit 130 may calculate an average value of the color coordinates of the extracted colors and may generate a color corresponding to the average value as the mixed color information. For example, when two numbers are included in the mathematical operation and RGB color coordinates corresponding to the two numbers are respectively (R1, G1, B1) and (R2, G2, B2), the RGB color coordinate of a mixed color may be ((R1+R2)/2, (G1+G2)/2, (B1+B2)/2).

Since the RGB color coordinates of the red color and the blue color are (255, 0, 0) and (0, 0, 255), respectively, in the previous example, the RGB color coordinate of the mixed color may be (128, 0, 128).

The image conversion unit 140 extracts a rectangular region that surrounds the 2D image acquired by the imaging unit 110, and performs image warping with respect to the extracted rectangular region, thereby generating a 3D image corresponding to the 2D image.

Image warping may be used to correct distortion of a digital image via a manipulation, such as adjustment of a distance between coordinates that constitute an image. The image warping performed by the image conversion unit 140 is used to correct the 2D image captured by the imaging unit 110 into a rectangular image.

The image conversion unit 140 may extract a feature point from a 2D image having undergone the image warping and may generate the 3D image by using the extracted feature point. The 2D image may include a plurality of feature points, and a 3D image corresponding to the coordinates of the plurality of feature points may be previously determined.

The display unit 150 outputs the 3D image generated by the image conversion unit 140 and a 3D image of a number corresponding to a result of the calculation by the calculation unit 120. At this time, the 3D image of the number corresponding to the result of the calculation by the calculation unit 120 is displayed in the mixed color generated by the color mixing unit 130.

In the previous example, the result of the mathematical operation of 6+3, which is 9, is output via the display unit 150. At this time, the number 9 is displayed in a violet color, which is the mixed color of the red color corresponding to the number 6 and the blue color corresponding to the number 3.

The acquisition of the 2D image by the imaging unit 110 and the display of the 3D image, as a final result, are sequentially performed, and also in real time.

When the imaging unit 110 heads for the 2D image, the display unit 150 may output the 2D image to the user in real time, and simultaneously the display unit 150 may display the 3D image generated by the image conversion unit 140 by partially overlapping the 2D image.

FIG. 2 illustrates a 2D image of a mathematical operation that is input to the mixed color content providing system 100.

Referring to FIG. 2, a form of the mathematical operation of the 2D image captured by the imaging unit 110 includes a plurality of numbers and an operation symbol, namely, a first number num 1, a second number num 2, and a first operation symbol sym 1.

The first operation symbol sym 1 may be one of the four fundamental arithmetic operation symbols, and the mathematical operation form may include at least three numbers and at least two operation symbols. In other words, the mathematical operation form may be a mathematical operation whose result may be calculated by the calculation unit 120.

The mathematical operation form may be formed by a user arranging a plurality of numbers and an operation symbol. The numbers included in the mathematical operation form are user-participating 2D images, and thus may be colored with a single color by the user. Accordingly, the color coated on the numbers is not predetermined, and may vary depending on a selection of the user.

The image conversion unit 140 generates the 3D image by performing image conversion with respect to the numbers and the operation symbol. The 3D image includes the color of the 2D image corresponding to the 3D image.

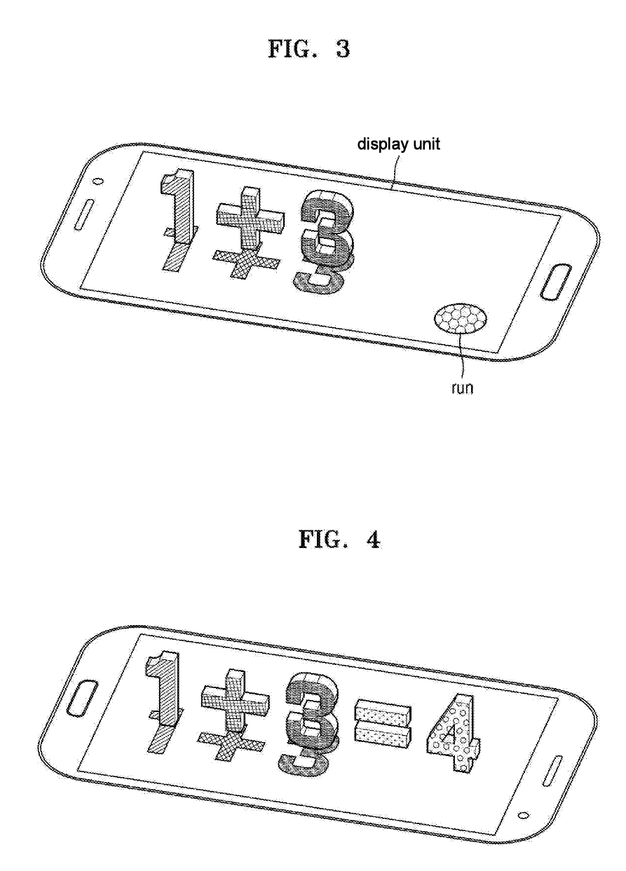

FIG. 3 illustrates a display via the display unit 150.

Referring to FIG. 3, the display unit 150 displays a 3D image corresponding to a 2D image. The 2D image is a mathematical operation as described above with reference to FIG. 2 and may be understood as an image captured by the imaging unit 110, and the 3D image is generated from the 2D image by the image conversion unit 140.

Referring to FIG. 3, the display unit 150 may display the 3D image generated by the image conversion unit 140 at a location corresponding to the 2D image by overlapping the 3D image with the 2D image.

In other words, the display unit 150 may simultaneously display the 2D image captured by the imaging unit 110 and the 3D image generated by the image conversion unit 140. Since the 2D image captured by the imaging unit 110 is a real image and the 3D image generated by the image conversion unit 140 is a virtual image, the 3D image may be augmented and displayed.

The imaging unit 110 and the display unit 150 may be included in a single terminal device as shown in FIG. 3, and a camera of FIG. 3 corresponding to the imaging unit 110 may be disposed on a rear surface of the terminal device of FIG. 3.

According to another embodiment of the present invention, the mixed color content providing system 100 may be implemented by the single terminal device. The calculation unit 120, the color mixing unit 130, and the image conversion unit 140 may be implemented via an application that may be installed in the terminal device.

When the application is executed, the camera corresponding to the imaging unit 110 operates to acquire the 2D image of the mathematical operation. Simultaneously, the 2D image acquired by the camera may be displayed on a display panel of the terminal device that corresponds to the display unit 150. The 3D image generated from the 2D image may be augmented at a location corresponding to the location of the 2D image and may be displayed together with the 2D image.

Referring back to FIG. 3, the display unit 150 may further display a run button run. When the run button is selected, a result in which the calculation result of the calculation unit 120 and the mixed color information of the color mixing unit 130 are reflected may be displayed via the display unit 150.

FIG. 4 illustrates a color mixing result and a calculation result displayed via the display unit 150.

Referring to FIG. 4, the display unit 150 displays a mathematical operation and a result of the mathematical operation. In FIG. 4, the display unit 150 displays a result of the mathematical operation calculated by the calculation unit 120. At this time, 4 corresponding to the result of the mathematical operation is displayed in a color obtained by mixing the colors corresponding to the numbers included in the mathematical operation.

As described above with reference to FIG. 1, the color mixing unit 130 may calculate an average value of the color coordinates of the extracted colors and may generate a color corresponding to the average value as the mixed color information.

For example, when two numbers are included in the mathematical operation and RGB color coordinates corresponding to the two numbers are respectively (R1, G1, B1) and (R2, G2, B2), the RGB color coordinate of a mixed color may be ((R1+R2)/2, (G1+G2)/2, (B1+B2)/2). Accordingly, when 1 and 3 included in the mathematical operation are colored with a red color and a blue color by a user, 4, which is the result of the mathematical operation, may be displayed in a violet color.

In FIG. 4, the mathematical operation and the result of the mathematical operation are displayed in the form of a 3D image, and a 2D image of an equal sign and a 2D image of the result of the mathematical operation are not displayed, because the mathematical operation configured by the user does not include the equal sign and the result.

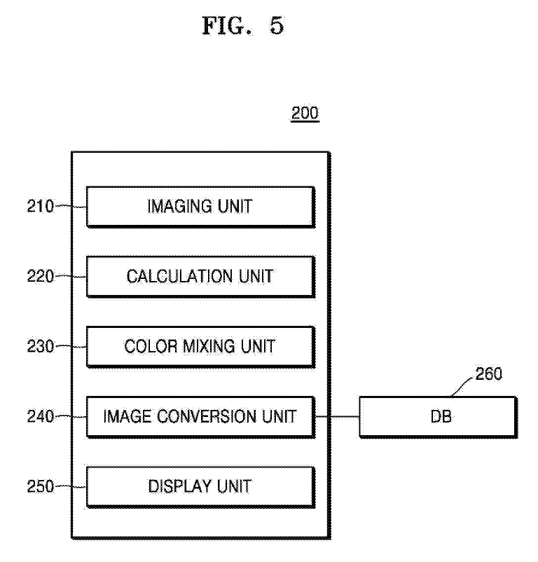

FIG. 5 is a schematic block diagram of a mixed color content providing system 200 according to another embodiment of the present invention.

Referring to FIG. 5, the mixed color content providing system 200 includes an imaging unit 210, a calculation unit 220, a color mixing unit 230, an image conversion unit 240, a display unit 250, and a database (DB) 260.

The imaging unit 210, the calculation unit 220, the color mixing unit 230, the image conversion unit 240, and the display unit 250 perform substantially the same functions as the imaging unit 110, the calculation unit 120, the color mixing unit 130, the image conversion unit 140, and the display unit 150 of FIG. 1, and thus repeated descriptions thereof will not be given.

The DB 260 stores a plurality of 3D images, and the 3D images correspond to 2D images having undergone image warping in the image conversion unit 240. The 2D images having undergone image warping in the image conversion unit 240 may also be stored in the DB 260 by being matched with the 3D images respectively corresponding to the 2D images.

The image conversion unit 240 performs image warping with respect to the 2D image captured by the imaging unit 210, and searches the DB 260 for a 3D image corresponding to a 2D image that has undergone the image warping.

The found 3D image may be output via the display unit 250. As described above with reference to the preceding drawings, the 3D image is displayed in the color used to color the 2D image corresponding to the 3D image.

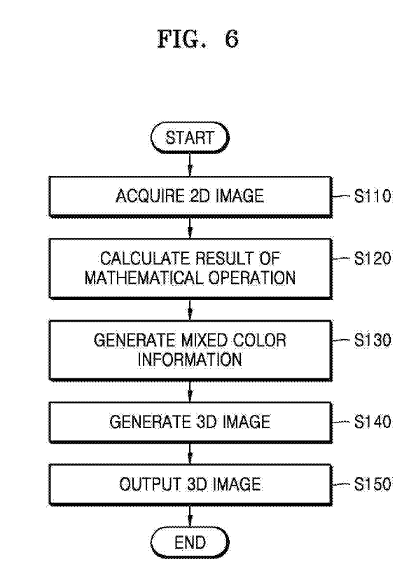

FIG. 6 is a schematic flowchart of a mixed color content providing method according to an embodiment of the present invention.

Referring to FIG. 6, the mixed color content providing method is performed by a terminal device including an imaging unit and a display unit, and includes a 2D image acquisition operation S110, a mathematical operation calculation operation S120, a mixed color information generation operation S130, a 3D image generation operation S140, and a 3D image outputting operation S150.

In the 2D image acquisition operation S110, the imaging unit captures a 2D image corresponding to a plurality of numbers and an operation symbol that constitute a mathematical operation. The 2D image may be provided as a user-participating image, and each of the plurality of numbers may be colored by a user.

In the mathematical operation calculation operation S120, a result of the mathematical operation is calculated. For example, when the mathematical operation is 6+3, 9, which is a result of the mathematical operation, is calculated in the mathematical operation calculation operation S120. Accordingly, in the mathematical operation calculation operation S120, the numbers and the operation symbol included in the mathematical operation may be distinguished from the 2D image acquired in the 2D image acquisition operation S110.

In the mixed color information generation operation S130, colors respectively corresponding to the plurality of numbers are extracted, and mixed color information of the extracted colors is generated. For example, when a color corresponding to 6 included in the mathematical operation and a color corresponding to 3 included therein are red and blue, respectively, a red color and a blue color may be extracted, and mixed color information corresponding to a violet color which is a mixed color of the extracted red and blue colors may be generated, in the mixed color information generation operation S130.

In the mixed color information generation operation S130, an average value of the color coordinates of the extracted colors may be calculated, and a color corresponding to the average value may be generated as the mixed color information. For example, when two numbers are included in the mathematical operation and RGB color coordinates corresponding to the two numbers are respectively (R1, G1, B1) and (R2, G2, B2), the RGB color coordinate of a mixed color may be ((R1+R2)/2, (G1+G2)/2, (B1+B2)/2).

Since the RGB color coordinates of the red color and the blue color are (255, 0, 0) and (0, 0, 255), respectively, in the previous example, the RGB color coordinate of the mixed color may be (128, 0, 128).

In the 3D image generation operation S140, a rectangular region that surrounds the 2D image is extracted and undergoes image warping, thereby generating a 3D image corresponding to the 2D image.

Image warping may be used to correct distortion of a digital image via a manipulation, such as adjustment of a distance between coordinates that constitute an image. The image warping performed in the 3D image generation operation S140 may be used to correct the 2D image captured in the 2D image acquisition operation S110 into a rectangular image.

In the 3D image generation operation S140, a feature point may be extracted from a 2D image having undergone the image warping, and the 3D image may be generated by using the extracted feature point. The 2D image may include a plurality of feature points, and a 3D image corresponding to the coordinates of the plurality of feature points may be previously determined.

In the 3D image outputting operation S150, the 3D image generated in the 3D image generation operation S140 and a 3D image of a number corresponding to the result of the calculation are output via the display unit. At this time, the 3D image of the number corresponding to the result of the calculation is displayed in the mixed color generated in the mixed color information generation operation S130.

In the previous example, the result of the mathematical operation 6+3, which is 9, is output in the 3D image outputting operation S150. At this time, the number 9 is displayed in a violet color, which is the mixed color of the red color corresponding to the number 6 and the blue color corresponding to the number 3.

The acquisition of the 2D image in the 2D image acquisition operation S110 and the display of the 3D image, as a final result, in the 3D image outputting operation S150 are sequentially performed and also performed in real time.

When the imaging unit heads for the 2D image in the 2D image acquisition operation S110, the 2D image may be output to the user in real time via the display unit in the 3D image outputting operation S150, and simultaneously the 3D image generated in the 3D image generation operation S140 may be displayed by partially overlapping the 2D image, in the 3D image outputting operation S150.

In the 3D image outputting operation S150, the 3D image may be coated with the colors extracted in the mixed color information generation operation S130. In other words, a 3D image corresponding to 6 included in the mathematical operation may be displayed in red, and a 3D image corresponding to 3 included in the mathematical operation may be displayed in blue.

In the 3D image outputting operation S150, the 3D image may be acquired from a DB that stores the 2D image having undergone the image warping and the 3D image corresponding to the 2D image.

The DB stores a plurality of 3D images, and the 3D images correspond to 2D images having undergone image warping in the 3D image generation operation S140. The 2D images having undergone image warping in the 3D image generation operation S140 may also be stored in the DB by being matched with the 3D images respectively corresponding to the 2D images.

In the 3D image generation operation S140, image warping may be performed on the 2D image acquired in the 2D image acquisition operation S110, and a 3D image corresponding to a 2D image having undergone the image warping may be searched for in the DB.

The found 3D image may be output in the 3D image outputting operation S150. As described above with reference to the preceding drawings, the 3D image is displayed in the color used to color the 2D image corresponding to the 3D image.

In the 3D image outputting operation S150, the 3D image generated in the 3D image generation operation S140 may be displayed at a location corresponding to the 2D image by overlapping the 2D image.

In other words, the 3D image outputting operation S150, the 2D image captured in the 2D image acquisition operation S110 and the 3D image generated in the 3D image generation operation S140 may be simultaneously displayed. Since the 2D image captured in the 2D image acquisition operation S110 is a real image and the 3D image generated in the 3D image generation operation S140 is a virtual image, the 3D image may be augmented and displayed.

One or more embodiments include a mixed color content providing system, a mixed color content providing method, and a computer-readable recording medium, by which users' interests are caused and users' participation is increased by generating a three-dimensional (3D) image from a two-dimensional (2D) image of a mathematical operation selected by a user and by providing a result of the mathematical operation and color mixing information.

The present invention can be embodied as computer readable codes on a non-transitory computer readable recording medium. The non-transitory computer readable recording medium is any type of recording device that stores data which can thereafter be read by a computer system.

Examples of the non-transitory computer-readable recording medium include ROM, RAM, CD-ROMs, magnetic tapes, floppy discs, and optical data storage media.

The non-transitory computer readable recording medium can also be distributed over network coupled computer systems so that the computer readable code is stored and executed in a distributive manner. Also, functional programs, codes, and code segments for accomplishing the inventive concept can be easily construed by programmers skilled in the art to which the inventive concept pertains.

The steps of all methods described herein can be performed in any suitable order unless otherwise indicated herein or otherwise clearly contradicted by context. Embodiments of the present invention are not limited to the described order of the operations.

The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to one of ordinary skill in the art without departing from the spirit and scope.

Therefore, the scope of the present invention is defined not by the detailed description but by the appended claims, and all differences within the scope will be construed as being included in the present invention.

What is claimed is:

1. A mixed color content providing system comprising:
an imaging unit configured to acquire a two-dimensional (2D) image corresponding to a plurality of numbers and an operation symbol that constitute a mathematical operation;
a calculation unit configured to calculate a result of the mathematical operation;
a color mixing unit configured to extract colors respectively corresponding to the plurality of numbers and to generate mixed color information of the extracted colors;
an image conversion unit configured to extract a rectangular region that surrounds the 2D image acquired by the imaging unit, and to perform image warping with respect to the extracted rectangular region to thereby generate a three-dimensional (3D) image corresponding to the 2D image; and
a display unit configured to output the 3D image generated by the image conversion unit and a 3D image of a number corresponding to the calculation result from the calculation unit, wherein the 3D image of the number corresponding to the calculation result is displayed in a mixed color generated by the color mixing unit.

2. The mixed color content providing system of claim 1, wherein the image conversion unit is configured to:
detect a plurality of coordinates corresponding to feature points of a 2D image that has undergone the image warping and to generate the 3D image by using the detected coordinates; and
color the 3D image with colors extracted by the color mixing unit.

3. The mixed color content providing system of claim 1, wherein the image conversion unit is configured to acquire the 3D image from a database (DB) that stores a 2D image that has undergone the image warping and a 3D image corresponding to the image-warped 2D image.

4. The mixed color content providing system of claim 1, wherein
the imaging unit and the display unit are included in a single terminal device, and
the 2D image acquired by the imaging unit is displayed together with the 3D image output via the display unit.

5. The mixed color content providing system of claim 1, wherein the color mixing unit is configured to calculate an average value of color coordinates of the extracted colors and to generate a color corresponding to the average value as the mixed color information.

6. The mixed color content providing system of claim 1, wherein the display unit is configured to display the 3D image generated by the image conversion unit at a location corresponding to the 2D image by overlapping the 3D image with the 2D image.

7. A mixed color content providing method performed by a terminal device comprising an imaging unit and a display unit, the mixed color content providing method comprising:
acquiring a 2D image corresponding to a plurality of numbers and an operation symbol that constitute a mathematical operation, by using the imaging unit;
calculating a result of the mathematical operation;
extracting colors respectively corresponding to the plurality of numbers and generating mixed color information of the extracted colors;
extracting a rectangular region that surrounds the acquired 2D image, and performing image warping with respect to the extracted rectangular region to thereby generate a 3D image corresponding to the 2D image; and
outputting the 3D image generated in the generating of the 3D image and a 3D image of a number corresponding to the result of the mathematical operation via the display unit, wherein the 3D image of the number corresponding to the result of the mathematical operation is displayed in a mixed color generated in the generating of the mixed color information.

8. The mixed color content providing method of claim 7, wherein the generating of the 3D image comprises:
detecting a plurality of coordinates corresponding to feature points of a 2D image that has undergone the image warping and generating the 3D image by using the detected coordinates; and
coloring the 3D image with colors extracted in the generating of the mixed color information.

9. The mixed color content providing method of claim 8, wherein the generating of the 3D image comprises acquiring the 3D image from a DB that stores the 2D image that has undergone the image warping and a 3D image corresponding to the image-warped 2D image.

10. The mixed color content providing method of claim 7, wherein the generating of the mixed color information comprises calculating an average value of color coordinates of the extracted colors and generating a color corresponding to the average value as the mixed color information.

11. The mixed color content providing method of claim 7, wherein the outputting of the 3D image comprises displaying the 3D image generated in the generating of the 3D image at a location corresponding to the 2D image by overlapping the 3D image with the 2D image.

12. A non-transitory computer-readable recording medium having recorded thereon a program for executing the method of claim 7.

13. A non-transitory computer-readable recording medium having recorded thereon a program for executing the method of claim 8.

14. A non-transitory computer-readable recording medium having recorded thereon a program for executing the method of claim 9.

15. A non-transitory computer-readable recording medium having recorded thereon a program for executing the method of claim 10.

16. A non-transitory computer-readable recording medium having recorded thereon a program for executing the method of claim 11.
